(19) United States
(12) Patent Application Publication
(10) Pub. No.: US 2009/0028656 A1
(43) Pub. Date: Jan. 29, 2009

(54) Force monitoring and control of router

(75) Inventor: Joel C. Forker, Knoxville, TN (US)

Correspondence Address: KNOX PATENTS, P.O. BOX 30034, KNOXVILLE, TN, 37930-0034, US

(73) Assignee: SAWING SYSTEMS INC.

(21) Appl. No.: 12/179,931

(22) Filed: Jul. 25, 2008

Related U.S. Application Data
(60) Provisional application No. 60/952,004, filed on Jul. 26, 2007.

(51) Int. Cl. B23C 1/18

(52) U.S. Cl. 409/80

(57) ABSTRACT

An apparatus for force monitoring and control of a multi-axis router. The spindle assembly has a mounting plate that is attached to a base plate in the router assembly through three equally spaced load cells. The load cells are maintained in tension because the spindle assembly is suspended below the base plate. The center of gravity of the spindle assembly is in the center of the three load cells. Forces on the cutting tool are measured by the load cells, which are monitored by a controller that determines the load on the cutting tool. The feed rate of the cutting tool is adjusted based on the calculated cutting tool force. Abnormal conditions, such as an unbalanced or dull tool, are determined from the measured forces.

### CROSS-REFERENCE TO RELATED APPLICATIONS

This application claims the benefit of U.S. Provisional Application No. 60/952,004, filed Jul. 26, 2007.

### STATEMENT REGARDING FEDERALLY SPONSORED RESEARCH OR DEVELOPMENT

Not Applicable

### BACKGROUND OF THE INVENTION

1. Field of Invention

This invention pertains to a force monitoring and control system for a multi-axis router machine.

2. Description of the Related Art

Router cutting tools controlled by numerical control systems have been in use for many years. Numerical control systems have eliminated manual operations such as controlling the feed motion of the table axes. However, router operators are still required to override the feed rate of the cutting tool regardless of the feed rate normally commanded by the numerical control system. There is a conflict in commercial router use. The conflict lies in the fact that heavy load machining will reduce machine time, but the heavy load may exceed the allowable value for the tool, causing breakage or excessive wear. Where the load is decreased, the feed rate is low, thus reduced output.

Conventional numerically controlled routers run at pre-defined feed rates that have been determined empirically. Extensive charts show the best feed rate for a given material, tool, and depth of cut. Naturally formed materials, such as stone, may have pockets of varying hardness. Due to the variety and inconsistency of the properties of naturally formed materials, the optimum feed rates for many such materials have not been well documented. Further, the value and any variance of the properties for a single piece of material is not readily determined. Force monitoring and control is one way of operating the router optimally without having empirical data. The router can run automatically at the maximum feed rate for a desired feed force without the need to pre-program the feed rate. Force monitoring and control is also a way to develop this feed rate data. The feed rate can be recorded over time to establish a range and average for the feed force applied to a given material.

The system in which force monitoring and control is used operates best when the force measurements taken during operation of the machine are accurate. The prior art force monitoring and control system disclosed in U.S. Pat. No. 4,698,773, issued to Jeppsson in Oct. 6, 1987 provides strain gages “attached to buttresses 16 . . . which sense the side loading force on the cutting tool 12 during the milling operation.” The Jeppsson Patent also provides for strain gages “attached to the housing's cylindrical surface on four places 90 degrees apart.” In both cases, the strain gage arrangement measures only side loading forces strong enough to flex the rigid structure of the spindle assembly.

### BRIEF SUMMARY OF THE INVENTION

For a router, maximizing both the feed rate and tool life based on the properties of the material being cut and the nature of the cut being made requires accurate force monitoring data. Accurate force monitoring data is provided by locating the spindle assembly of the router in such a way that the weight of the spindle assembly is supported by two or more load cells, or sensors, which detect the relative force, or feed force, between the work piece and the cutting tool during operation. The speed of an axial drive motor, which establishes the feed rate of the work piece relative to the cutting tool, is adjusted when the change in the feed force detected by the load cells reaches a threshold level.

Also, for a router, detecting an unbalanced tool is accomplished by locating three or more load cells that support the weight of a spindle assembly such that they encircle the axis of rotation of the cutting tool. In that way, a rotating force is detected when the indicated direction of the force changes in a cyclical pattern matching the rotation of the cutting tool. Such a rotating force identifies a damaged cutting tool, such as a chipped or broken cutting tool.

Further, for a router with improved force monitoring and control, interchangeability of spindle assemblies is provided for by an opening in the spindle support structure that bears on a number of load cells. In this way, different spindle assemblies with different torque and/or speed characteristics are alternately installed on the same machine.

According to one embodiment of the present invention, force monitoring and control of a multi-axis router machine is provided. The router machine is a gantry-style machine with x, y, and z travel control of the router assembly. The router assembly includes a spindle assembly suspended from three load cells attached to a base plate such that the load cells are in tension. The spindle assembly includes a cutting tool having an axis of rotation. Each of the three load cells are located at an apex of an equilateral triangle. The midpoint of the equilateral triangle is at or near the axis of rotation of the cutting tool. In other embodiments, the spindle assembly hangs from the load cells such that the load cells are in compression.

One spindle assembly includes a motor that rotates a cutting tool at high speed. Another spindle assembly includes a motor that rotates a cutting tool at a high torque. Typically, the side of the cutting tool engages the work piece and performs the cutting. In one embodiment, the motor is positioned adjacent the rotational axis of the cutting tool and a weight stack is positioned opposite the motor to counterbalance the motor's weight. In another embodiment, the motor is in-line with the spindle and a weight stack is not needed as a counterbalance.

The load cells monitor the component of the cutting force on the cutting tool that is perpendicular to the axis of rotation of the cutting tool. In one embodiment, a controller receives input from the load cells. The load cells output individual tensile or compression force data during operation of the router machine. The controller determines the cutting force on the cutting tool and determines appropriate actions for the routing machine. If the cutting tool is operating inefficiently with less than its maximum force, the feed rate of the cutting tool is increased. If the cutting tool is at its maximum force level, but the feed rate is at or less than a minimum feed rate, then the tool is dull and needs to be replaced or repaired. If the cutting force is rotating, then the cutting tool is not balanced and needs to be replaced or repaired. In another embodiment, the outputs of the load cells are displayed on an analog device and the feed rate is adjusted manually.

The spindle assembly is interchangeable in that the motor is installed with a quick connect assembly and the rest of the spindle assembly is suspended by the three load cells. An opening in the base plate allows the spindle assembly to be removed from the router assembly by moving it perpendicular to the axis of rotation of the cutting tool.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of one embodiment of a three-axis router;

FIG. 2 is a partial cross-sectional view of one embodiment of the z-axis slides for the router spindle;

FIG. 3 is a partial cross-sectional view showing one embodiment of the top of the router assembly;

FIG. 4 is a partial side view of one embodiment of the router assembly;

FIG. 5 is a symbolic diagram showing the motion and force vectors;

FIG. 6 is a symbolic diagram showing the force vectors in the x-z plane;

FIG. 7 is a block diagram of one embodiment of feed rate control; and

FIG. 8 is a flow diagram illustrating one embodiment of the process of force control.

### DETAILED DESCRIPTION OF THE INVENTION

An apparatus for force monitoring and control of a cutting tool for a multi-axis router is disclosed. This type of router is suited for automatic control for cutting large work pieces, such as architectural stone, and smaller work pieces, such as wood and metal manufactured components.

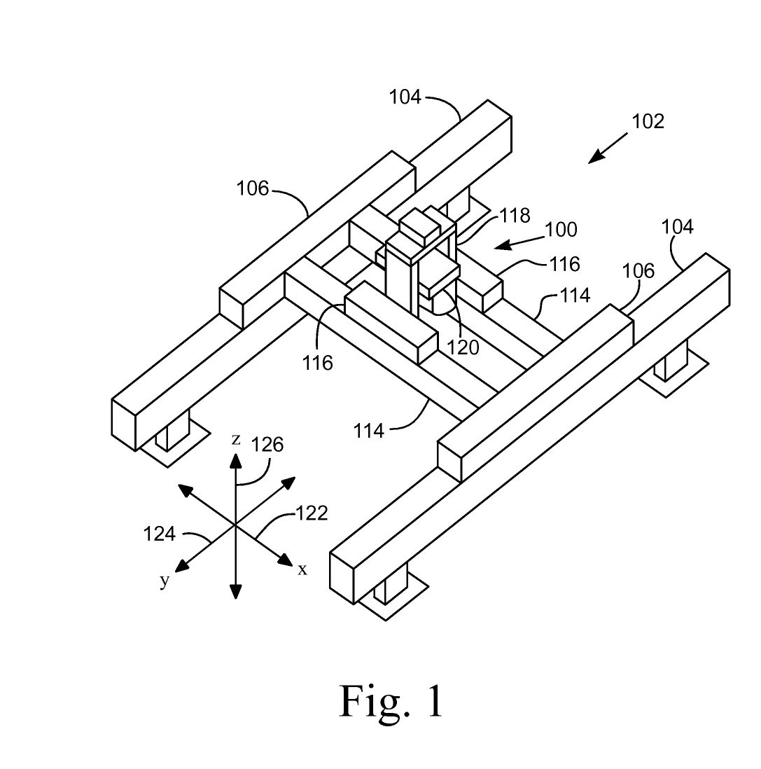

FIG. 1 illustrates a perspective view of one embodiment of a three-axis router machine 102. A pair of parallel tram rails 104 are supported on a floor or other support surface. Riding on each of the tram rails 104 is a truck 106, which supports one end of a pair of main rails 114. The trucks 106 move in tandem along the tram rails 104 along a y-axis 124. Riding on each of the main rails 114 is a carriage 116, which supports a slide 118. The carriages 116 move in tandem along the main rails 114 along an x-axis 122. The slides 118 on the carriages 116 move the router assembly 100 along the z-axis 126. The illustrated router assembly 100 includes a top cover 120 to protect the mechanism of the router assembly 100 from dust, dirt, and other contaminants.

The trucks 106 and the carriages 116 include driving mechanisms to move the trucks 106 and the carriages 116 along the respective rails 104, 114. Control of the positions of the trucks 106 and the carriages 116 allows the router assembly 100 to assume a specified x, y coordinate position.

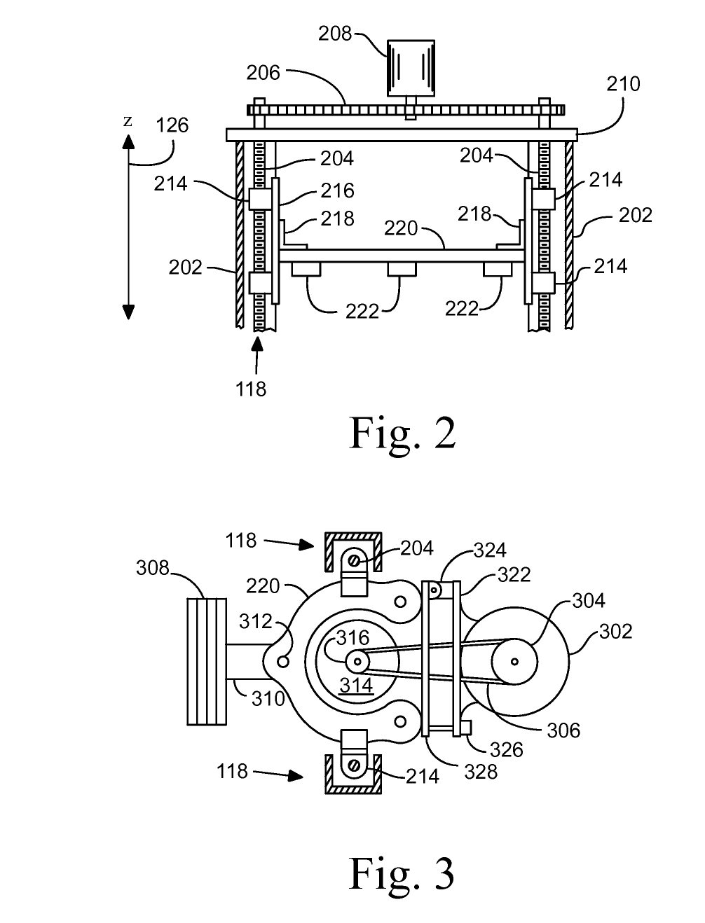

FIG. 2 illustrates a partial cross-sectional view of one embodiment of the z-axis 126 slides 118 for the router assembly 100. Each slide 118 is attached to and carried by one carriage 116. A bridge 210 connects the tops of the two slides 118. The slides 118 each include a housing 202 that contains a lead screw 204. The lead screw 204 is rotated by a motor 208 that drives a chain 206 engaging a sprocket connected to the top of each lead screw 204. Each lead screw 204 has two ball nuts 214 that move along the z-axis 126 when the lead screw 204 rotates. Each pair of ball nuts 214 are attached to a plate 216 that is connected to the router assembly 100 with brackets 218. In the illustrated embodiment, the router assembly 100 includes the base plate 220 and the three load cells 222 attached to the bottom of the base plate 220. In other embodiments, the number of load cells 222 varies and/or the load cells 222 are attached to the top of the base plate 220 or the load cells 222 are attached to the side of the base plate 220. Because of the connection of the base plate 220 to the ball nuts 214, the router assembly 100 moves along the z-axis 126 in response to the motor 208 rotating the lead screws 204.

The illustrated pair of slides 118 offers the advantage for supporting the router assembly 100 on two opposing sides, thereby eliminating a cantilevered effect for a router assembly 100 that is supported on only one side. With the spindle 402 centered between the pair of slides 118, the spindle 402 is symmetrically supported and is subject to less deflection under load.

FIG. 3 illustrates a partial cross-sectional view showing of one embodiment the top of the router assembly 100 below the bridge 210. The base plate 220 is horse-shoe-shaped such that one end is open for removal of the spindle assembly 314, that is, the base plate 220 has a slot through which the spindle assembly 314 can be removably attached to the base plate 220. Visible on top of the base plate 220 are the fasteners 312 for the load cells 222. In the illustrated embodiment, the fasteners 312 are positioned at each apex of an equilateral triangle and the center of the triangle coincides with the axis of rotation 426 of the spindle 402. In other embodiments, the location of each load cell 222 with respect to the axis of rotation 426 varies.

Extending on one side of the router assembly 100 is a weight stack 308 attached to an extension arm 310. On the opposite side is a spindle motor 302. The weight stack 308 offsets the weight of the spindle motor 302 to ensure that the center of gravity of the spindle assembly 314 falls on or very near the axis of rotation 426 of the spindle assembly 314.

In the illustrated embodiment, the spindle motor 302 drives a drive pulley 304 engaging an endless belt 306. The endless belt 306 engages a spindle pulley 316 on top of the spindle assembly 314. The rotational speed of the spindle motor 302 and the ratio of the drive pulley 304 to the spindle pulley 316 determine the rotational speed of the spindle 402.

The spindle motor 302 is attached to a first plate 322 that is connected to a second plate 328 by a hinge 324 and a latch, or quick release mechanism, 326. In the illustrated embodiment, releasing the latch 326 allows the first plate 322 to pivot relative to the second plate 328 to allow the endless belt 306 to be replaced or repositioned around pulleys 304, 316 having a different ratio so as to vary the speed of the spindle 402.

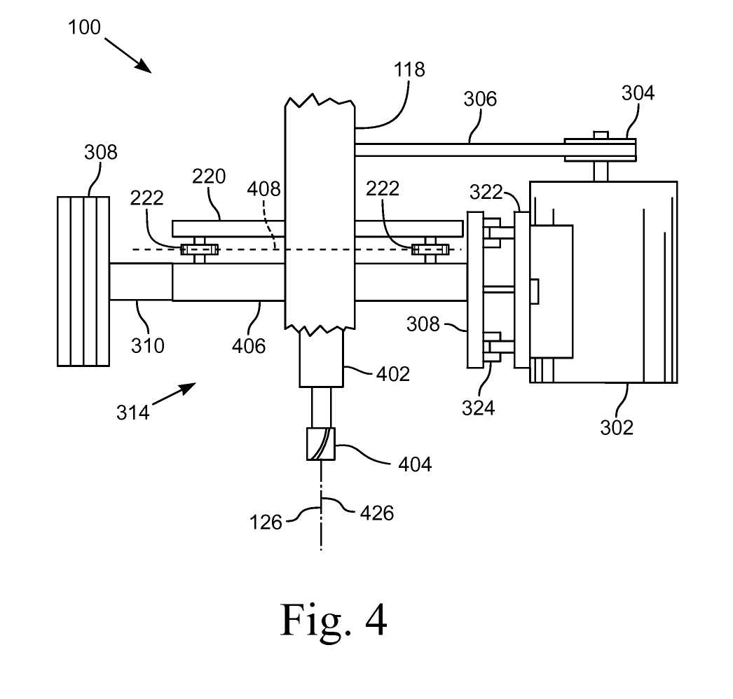

FIG. 4 illustrates a partial side view of one embodiment of the router assembly 100. The spindle 402, partially hidden behind the slide 118, has a cutting tool 404 attached at the distal end. The spindle 402 is rotationally attached to a mounting plate 406, which supports the spindle 402 and allows it to rotate about an axis of rotation 426 that is parallel with the z-axis 126.

The mounting plate 406 attaches to and is supported by the three load cells 222. The load cells 222 are sensors that measure a force, either compressive or tensile, along a measurement axis, which in the illustrated embodiment is the vertical axis. In the illustrated embodiment, the load cells 222 are in tension because of the weight of the spindle assembly 314. In one embodiment, the center of gravity of the spindle assembly 314, which is supported by the load cells 222, coincides with the intersection of the axis of rotation 426 with the horizontal plane 408 passing through the three load cells 222. In that way, movement of the router assembly 100 along the x-, y-, and/or z-axes 122, 124, 126 will apply equal forces to the load cells 222, that is, the load cells 222 will remain in equilibrium. In other embodiments, one or more load cells 222 are offset with respect to the other load cells 222.

The spindle assembly 314 is removable from the router assembly 100 by disengaging the fasteners 312 securing the mounting plate 406 to the load cells 222 and moving the spindle assembly 314 through the open side of the base plate 220. In order to facilitate the removal of the spindle assembly 314, the electrical connection to the motor 302 includes a quick-release connector. The removable spindle assembly 314 allows installation of a spindle assembly 314 suitable for the work to be performed. For example, a higher speed spindle assembly 314 is installed for smaller, high speed tooling engraving, or a high torque spindle assembly 314 is installed for heavy stock removal, polishing, or core drilling.

In another embodiment, the spindle 402 is directly coupled to the shaft of the spindle motor 302, which is mounted above and in-line with the cutting tool 404. In this embodiment, the weight stack 308 is not needed to counterbalance the weight of the spindle motor 302. The axial position of the spindle motor 302 and spindle 402 in one such embodiment is adjusted to ensure that the center of gravity of the spindle assembly 314 is in the plane of the load cells 222.

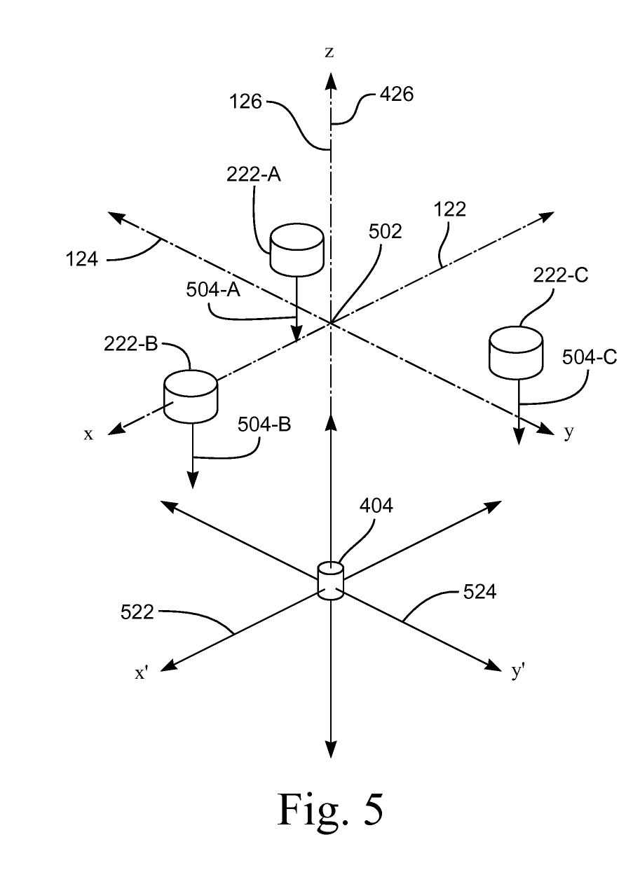

FIG. 5 illustrates a symbolic diagram showing the motion and force vectors associated with the spindle assembly 314 and the x-, y-, and z-axes 122, 124, 126 of the three-axis router 102 as the axes 122, 124, 126 pass through the horizontal plane of the load cells 222. In the illustrated embodiment, the three load cells 222-A, 222-B, 222-C encircle the axis of rotation 426 of the spindle 402 with a spaced apart relationship. The center of gravity 502 of the load cells 222 coincides with the intersection of the axis of rotation 426 with the horizontal plane 408 passing through the three load cells 222. Because the load cells 222 support the spindle assembly 314 from above, the load cells 222 are in tension, as indicated by the tension forces 504 associated with each load cell 222. Because the load cells 222 are attached to the base plate 220, which is fixed to the router 102, the center of gravity 502 of the load cells 222 is constrained to move along the x-, y-, and z-axes 122, 124, 126 of the router 102. In one embodiment, the load cells 222 are sensitive to loads applied axially, that is through their vertical axis, and the load cells 222 are not sensitive to off-axis loads. In other words, the load cells 222 are rigid to horizontal forces while detecting the vertical forces 504.

The cutting tool 404 is located a distance below the horizontal plane of the load cells 222. For illustration purposes, the cutting tool 404 has x′-, y′-, and z′-axes 522, 524, 526 that are parallel to the x-, and y-, and z-axes 122, 124, 126 of the router machine 102, respectively. The axis of rotation 426 of the cutting tool 404 coincides with the center of rotation of the spindle 402, which passes through the center of gravity 502 of the load cells 222. Because the cutting tool 404 is outside the plane of the load cells 222, any force along the x′-axis 522 and/or the y′-axis 524 will affect the load cells 222-A, 222-B, 222-C unequally because the cutting tool 404 is cantilevered from the load cells 222-A, 222-B, 222-C.

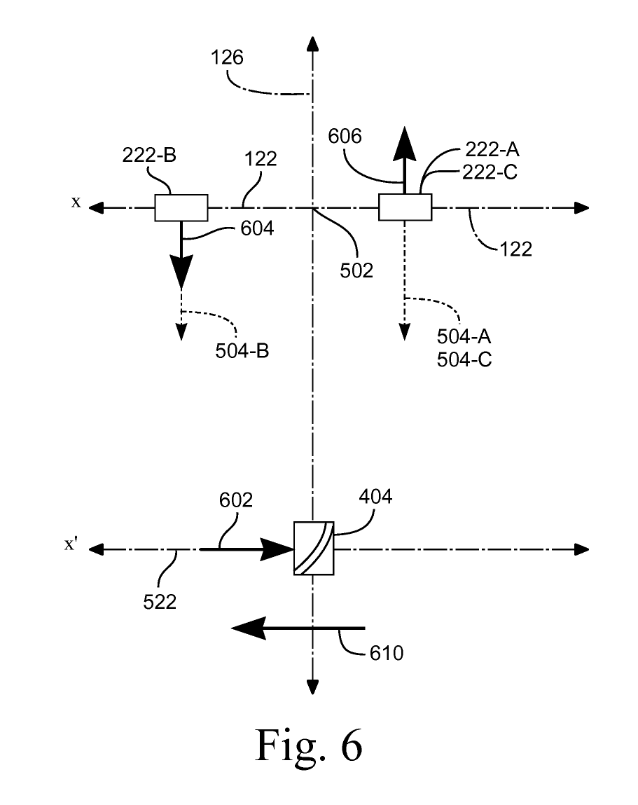

FIG. 6 illustrates a symbolic diagram showing the force vectors in the x-z plane for the spindle assembly 314. Because the cutting tool 404 is cantilevered, when the cutting tool 404 is moving along the x′-axis 522 in one direction 610, a cutting force 602 is applied to the cutting tool 404 by a work piece. This cutting force 602 results in a torque that causes the spindle assembly 314 to want to rotate about the center of gravity 502 of the load cells 222. The torque causes one load cell 222-B, which is on the x-axis 122, to detect a first resulting force 604 that adds to the tension force 522-B detected by the load cell 222-B when the cutting tool 404 is stationary. The other two load cells 222-A, 222-C, although not on the x-axis 122, are, in the illustrated embodiment, spaced equidistant from the x-axis 122 and detect a second resulting force 606 that is in the opposite direction of the tension force 522-A, 522-C. Each of the two load cells 222-A, 222-C supports a corresponding fraction of the second resulting force 606.

In practice, the cutting force 602 on the cutting tool 404 is unknown. But, the load cells 222 detect the first and second resulting forces 604, 606 applied to the three load cells 222 along their vertical axes. Because the distance between the centers of the three load cells 222-A, 222-B, 222-C and the location of the cutting force 602 is known, the magnitude and direction of the cutting force 602 applied to the cutting tool 404 is calculated by geometrically combining the first and second resulting forces 604, 606 applied to the load cells 222.

Additionally, for a steady state condition, such as when the cutting tool 404 is rotating, but not moving through the work piece, the force 602 rotates or moves around the circumference of the tool 404 indicating that the cutting tool 404 is not balanced, such as would occur if the cutting tool 404 were damaged or the spindle 402 were bent. A rotating force is one where it appears that the force 602 being applied to the tool 404 is moving around the circumference of the tool 404. Typically, if the mis-balanced condition is due to damage to a cutting surface of the cutting tool 404, the force 602 will rotate at the same speed that the spindle 402 rotates. When the cutting tool 404 is moving through the work piece, the force 602 has two components that are superimposed. The first component corresponds to the force of the tool 404 engaging the work piece. The second component corresponds to the rotating force caused by the unbalanced tool condition.

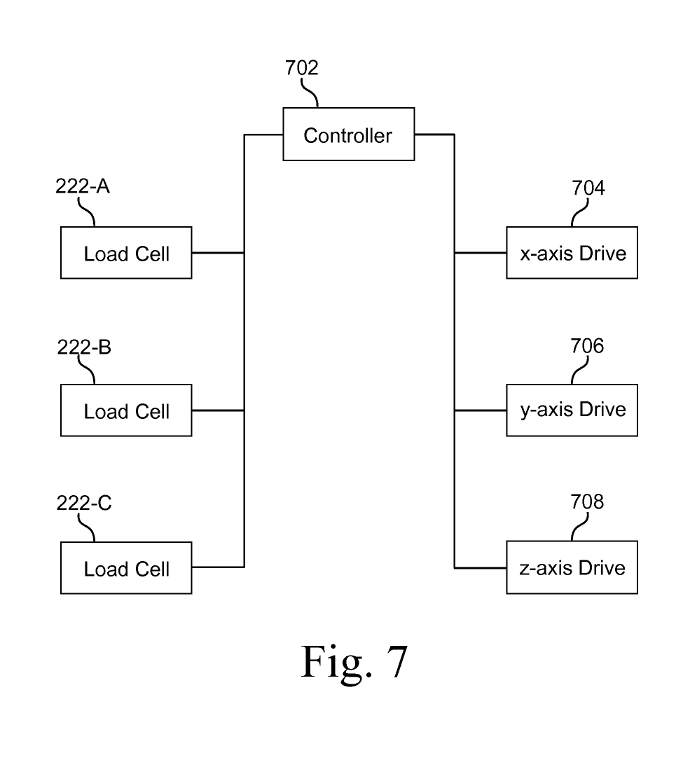

FIG. 7 illustrates a block diagram of one embodiment of feed rate control for the three-axis router machine 102. A controller 702 receives inputs from the three load cells 222-A, 222-B, 222-C. These inputs from the load cells 222 reflect both the tension loads 522 detected by the load cells 222 supporting the spindle assembly 314 and the instantaneous loads 604, 606 detected by the load cells 222 due to the cutting tool 404 rotating and interacting with the work piece. The controller 702 communicates with the x-axis drive 704, the y-axis drive 706, and the z-axis drive 708. In one embodiment, the controller 702 outputs feed rate information to the appropriate axial drives 704, 706, 708 in order to maintain the feed rate of the cutting tool 404 within certain parameters.

In one embodiment the drives 704, 706, 708 are motor controllers each connected to one or more motors that engage drive mechanisms that causes motion along the corresponding axis. In one embodiment, the controller 702 and the motors, or axial drives 704, 706, 708 are discrete components. In another embodiment, one or more of the controller 702 and the motor drives 704, 706, 708 are combined into a single unit. In still another embodiment, the controller 702 is an analog PID controller that receives inputs from each of the three load cells 222-A, 222-B, 222-C to control the feed rate.

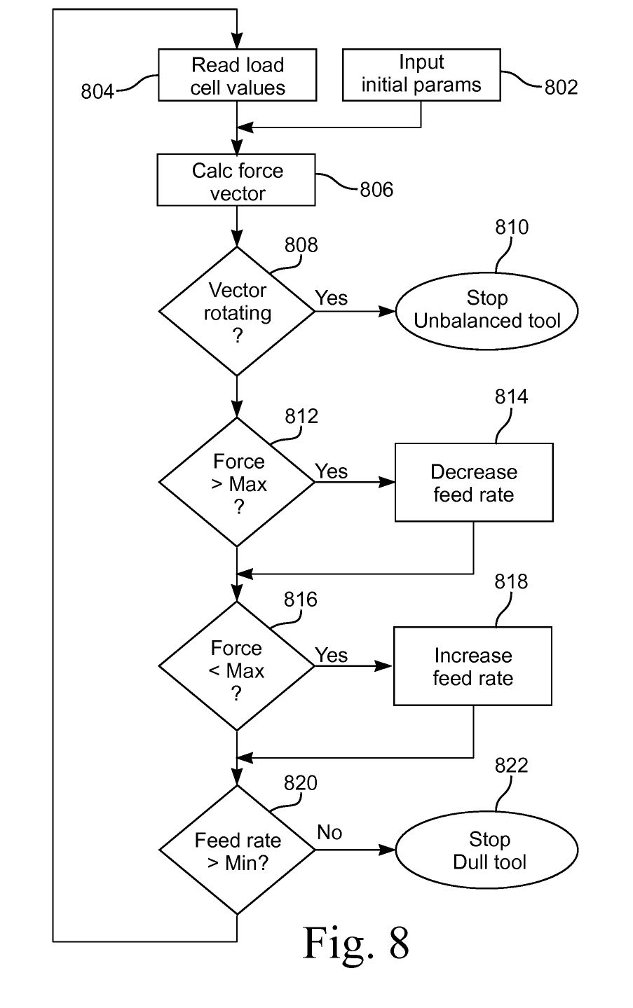

FIG. 8 illustrates one embodiment of a flow diagram illustrating the process of force control of the router machine 102. In the illustrated embodiment, the controller 702 stores information on the load cells 222, such as their angular position and their distance from the center 502 of the load cells 222, and information on the cutting tool 404, namely the distance the cutting tool 404 extends from the plane 408 of the load cells 222 and the location where the axis of rotation intersects the plane 408 of the load cells 222. This information is stored in the step 802 of inputting initial parameters. This step 802 is typically performed initially and thereafter whenever any of the stored parameters changes.

During normal operations, the controller 702 performs the step 804 of reading the output value of each load cell 222-A, 222-B, 222-C. Using the values from the load cells 222 and the stored information, the controller 702 performs the step 806 of calculating the force 602 on the cutting tool 404. The force 602 is then evaluated 808 to determine if it has a rotating component rotating. If the force 602 is rotating beyond specified limits, or a selected operating range, the controller 702 signals a stop for an unbalanced tool condition 810. In another embodiment, the controller 702 annunciates or otherwise indicates the existence of an unbalanced tool condition.

If the cutting force 602 is not rotating, the next step 812 is to evaluate the magnitude of the force 602 to determine if it is greater than a maximum allowed value in a selected operating range for that cutting tool 404. If the magnitude is greater than a maximum allowed value, the next step 814 is to reduce the feed rate of the cutting tool 404.

If the magnitude is less than the maximum allowed value, the next step 816 is to evaluate the magnitude of the cutting force 602 to determine if it is less than a maximum allowed value for that cutting tool 404. In one embodiment, the maximum allowed value is specified as a range of values. If the magnitude is less than the maximum allowed value, the next step 818 is to increase the feed rate of the cutting tool 404.

The next step, if either the magnitude is not less than the maximum allowed value or if the feed rate is increased 818, is to perform the step 820 of evaluating the feed rate to ensure it is above a minimum allowed value. If the feed rate is at or below a minimum allowed value, then the controller 702 signals a stop for a dull tool condition 822. In another embodiment, the controller 702 annunciates or otherwise indicates the existence of a dull tool condition.

The loop then repeats by performing the first step 804 of reading the inputs from each of the load cells 222-A, 222-B, 222-C.

Those skilled in the art will recognize that the evaluation steps 808, 812, 816, 820 can be performed in any order or even simultaneously without departing from the spirit and scope of the present invention.

As used herein, the controller 702 should be broadly construed to mean any computer or component thereof that executes software. The controller 702 includes a memory medium that stores software, a processing unit that executes the software, and input/output (I/O) units for communicating with external devices.

In one embodiment the controller 702 is a specialized device for implementing the identified functions, in another embodiment, it is a general purpose computer programmed to perform the identified functions. Those skilled in the art will recognize that the controller 702 includes an input component, an output component, a storage component, and a processing component. The input component receives input from external devices, such as the load cells 222. The output component sends output to external devices, such as the various drive controllers 704, 706, 708. The processing component executes software to produce a desired output based on the inputs. The storage component stores data and program code. In one embodiment, the storage component includes random access memory. In another embodiment, the storage component includes non-volatile memory, such as floppy disks, hard disks, and writeable optical disks.

In one embodiment, each of the functions identified in FIG. 8 are performed by one or more software routines executed by the controller 702. In another embodiment, one or more of the functions identified are performed by hardware and the remainder of the functions are performed by one or more software routines run by the controller 702. In still another embodiment, the functions are implemented with hardware, with the controller 702 providing routing and control of the entire router machine 102.

The controller 702 executes software, or routines, for performing various functions. These routines can be discrete units of code or interrelated among themselves. Those skilled in the art will recognize that the various functions can be implemented as individual routines, or code snippets, or in various groupings without departing from the spirit and scope of the present invention. As used herein, software and routines are synonymous. However, in general, a routine refers to code that performs a specified function, whereas software is a more general term that may include more than one routine or perform more than one function.

In another embodiment, the spindle assembly 314 is mounted on a five-axis router machine. In addition to the three rectangular coordinate x-, y-, and z-axes 122, 124, 126, the axis of rotation 426 pivots, or rotates, in the plane defined by the x-axis 122 and the z-axis 126, commonly called the c-axis or the a-axis, and in the plane defined by the y-axis 124 and the z-axis 126, commonly called the w-axis or b-axis. These additional two axes are typically referred to with respect to the standard tool direction. Assuming that the standard tool direction is along the x-axis 122, the a-axis is an axis of rotation about a line perpendicular to the x-axis 122 and intersecting the axis of rotation 426 of the tool 404. Assuming that the standard tool direction is along the x-axis 122, the b-axis is the tilt of the tool 404 along an axis of rotation parallel to the x-axis 122 and perpendicular to the z-axis 126.

In one embodiment, the configuration of the load cells 222 relative to the spindle assembly 314, that is, the center of gravity of the spindle assembly 314 being substantially coaxial with the center 502 of the load cells 222, allows for force monitoring and control of both a three-axis router machine 102 and a five-axis router machine.

The router assembly 100 includes various functions. The function of measuring a cutting tool 404 force 602 is implemented, in one embodiment, by the three load cells 222 supporting the spindle assembly 314. The load cells 222 output detected force data to a controller 702 that determines the condition of the cutting tool 404 and the feed rate of the cutting tool 404 to ensure long life of the cutting tool 404 and efficient operation of the router machine 102.

The function of detecting an unbalanced cutting tool 404 is implemented, in one embodiment, by determining that a component of the force 602 on the tool 404 is rotating. A force 602 is determined to be rotating by evaluating the outputs from each of the load cells 222-A, 222-B, 222-C supporting the spindle assembly 314.

The function of detecting a dull cutting tool 404 is implemented, in one embodiment, by determining that the feed rate is less than a pre-determined value for a specified force 602 on the cutting tool 404. The cutting force 602 on the cutting tool 404 is determined by evaluating the outputs, or measurements, from the load cells 222 supporting the spindle assembly 314, and the feed rate is determined from the appropriate axial drive 704, 706, 708.

The function of replacing the spindle assembly 314 is implemented, in one embodiment, by the attachment of the load cells 222 carrying the spindle assembly 314 in suspension and by the configuration of the base plate 202 having an open side, or slot, for passage of the spindle assembly 314.

The function of reducing sensitivity to directional changes of the router assembly 100 is implemented, in one embodiment, by the spindle assembly 314 having a center of gravity at or near the center 502 of the load cells 222. The location of the center of gravity of the spindle assembly 314 is determined, in part, by the position of the spindle drive 302 and weight stack 308 on opposite sides of the spindle 402.

The function of maximizing efficiency of the router machine 102 is implemented, in one embodiment, by ensuring that the greatest possible feed rate is maintained when cutting. The feed rate is controlled by the controller 702 evaluating the cutting force 602 on the cutting tool 404 and maintaining a high feed rate by keeping the cutting force 602 on the cutting tool 404 at a maximum allowed value.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An apparatus for monitoring and controlling forces on a router machine comprising:
a member configured to be supported by the router machine;
a plurality of sensors attached to said member, each of said plurality of sensors having an output corresponding to a sensor force applied to said each one of said plurality of sensors along a measurement axis; and
a spindle assembly supported by said plurality of sensors, said spindle assembly configured to receive a cutting tool rotatable about an axis of rotation, said plurality of sensors encircling said axis of rotation, said measurement axis of each one of said plurality of sensors substantially parallel to said axis of rotation, said plurality of sensors arranged such that a cutter force applied substantially perpendicular to said axis of rotation results in a torque applied to said spindle assembly, said torque being detectable by said plurality of sensors.

2. The apparatus of claim 1 wherein said plurality of sensors are regularly spaced around said axis of rotation

3. The apparatus of claim 1 further including a controller in communication with said plurality of sensors, said controller communicating with a drive, said drive controlling a feed rate of said spindle assembly, and said controller adjusting a speed of said drive to maintain a magnitude of said cutter force within specified limits.

4. The apparatus of claim 3 wherein said controller identifies an unbalanced tool condition, said controller determines that said unbalanced tool condition exists when said cutter force has a direction that varies over time compared to a feed direction.

5. The apparatus of claim 3 wherein said controller causes said feed rate to increase when said cutter force is less than a specified value.

6. The apparatus of claim 3 wherein said controller causes said feed rate to decrease when said cutter force is less than a specified value.

7. The apparatus of claim 1 further including a controller that identifies a dull tool condition, said controller determines that said dull tool condition exists based on a feed rate less than a minimum value for a specified magnitude of said cutter force.

8. The apparatus of claim 7 wherein said controller determines the existence of a dull tool condition when said magnitude of said cutter force is greater than a specified limit and said feed rate is less than a specific value.

9. The apparatus of claim 1 wherein said plurality of sensors includes three load cells arranged approximately at 120 degree intervals around said axis of rotation.

10. An apparatus for monitoring and controlling forces on a router machine comprising:
a spindle assembly configured to receive a cutting tool rotatable about an axis of rotation;
a plurality of sensors supporting said spindle assembly, each of said plurality of sensors having an output corresponding to a first force applied to said each one of said plurality of sensors along a measurement axis, said plurality of sensors responsive to a torque resulting from a second force applied substantially perpendicular to said axis of rotation; and
a controller receiving said output from each of said plurality of sensors, said controller configured to adjust a feed rate to maintain said second force within a specified range.

11. The apparatus of claim 10 wherein said torque causes said outputs of said plurality of sensors to correspond with a distribution, said distribution defining a direction of said second force.

12. The apparatus of claim 11 wherein said controller is configured to identify an unbalanced tool condition when said direction varies over time compared to a feed direction.

13. The apparatus of claim 10 wherein said controller is configured to identify a dull tool condition where said magnitude of said cutter force is greater than a specified limit and said feed rate is less than a specific value.

14. The apparatus of claim 10 wherein said plurality of sensors are spaced about said axis of rotation.

15. An apparatus for monitoring and controlling forces on a router machine comprising:
a member supported by the router machine;
a spindle assembly configured to receive a cutting tool rotatable about an axis of rotation,
three load cells attached to said member, said spindle assembly supported by said three load cells, said three load cells having three outputs, said three load cells spaced regularly around said axis of rotation, said three load cells responsive to a torque resulting from a force applied to said cutting tool; and
a controller receiving said three outputs, said controller configured to control at least one drive, said at least one drive causing said cutting tool to have a feed rate relative to a work piece, said controller causing said feed rate to vary to maintain said force less than a maximum value.

16. The apparatus of claim 15 wherein said controller determines that said force includes a rotating component wherein said controller identifies an unbalanced tool condition.

17. The apparatus of claim 15 wherein said controller causes said feed rate to vary to maintain said force greater than a minimum value.

18. The apparatus of claim 15 wherein said controller identifies a dull tool condition wherein said feed rate is less than a minimum value when said force is greater than a specified value.

19. The apparatus of claim 15 wherein said member includes a slot that allows said spindle assembly to be removably connected to said member.
